(19) United States
(12) Patent Application Publication
(10) Pub. No.: US 2017/0245648 A1
(43) Pub. Date: Aug. 31, 2017

(54) MULTIFUNCTIONAL ELECTRICALLY-CONNECTED FURNITURE

(71) Applicant: Stéphane CHARLEBOIS, Val des Monts (CA)

(72) Inventor: Stéphane CHARLEBOIS, Val des Monts (CA)

(21) Appl. No.: 15/217,620

(22) Filed: Jul. 22, 2016

Related U.S. Application Data
(60) Provisional application No. 62/301,540, filed on Feb. 29, 2016.

(51) Int. Cl. A47C 21/00; F21V 11/16

(52) U.S. Cl. CPC A47C 21/003; F21V 11/16; F21Y 2115/10

(57) ABSTRACT

A bed comprising a headboard having a forward face or a footboard having a forward face. At least one of the headboard and the footboard comprise a light board having a front surface and a back surface, with the light board being integrated to at least one of the headboard and the footboard such that the front surface faces a same direction as the forward face of either one of the headboard and the footboard. The light board comprises a light emitting device, a set of layers guiding light emitted by the light emitting device toward the front surface, and a translucent image film contained between the layers and blocking at least partially transmission of the light toward the front surface. A light board for a head or a foot of a bed is also described.

### CROSS-REFERENCE TO RELATED APPLICATION

This application claims priority from U.S. provisional patent application 62/301,540 filed Feb. 29, 2016, the specification of which is hereby incorporated herein by reference in its entirety.

### BACKGROUND

(a) Field

The subject matter disclosed generally relates to furniture and more particularly to customized and/or customizable decorative multi-functional electrically-connected furniture, particularly beds. The subject matter disclosed may also relate to beds featuring light sources and lit decorative elements.

(b) Related Prior Art

The desire to customize one's environment, to surround oneself with decorative elements has always been present in the human nature, and as technology evolved the importance of the decorative and aesthetic aspect of the design of the functional objects have constantly grown, including the customization of furniture. Accordingly, the population is seeking furniture that not only responds to functional requirements, but that also pleases the eye. To respond to such requirements, design has become more important in the development of new products, and with technical developments, the number of technical means and solutions to include decorative aspects in furniture elements have grown.

Particularly with respect to customization of beds, there have been substantial attempts to customize beds for the above reasons. For instance, there have been developments to include lighting, sound, screens or decorations in headboards or footboards.

In the prior art, KR200449698Y1 describes a bed having lighting in the headboard with a decorative grooved plate; KR200278196Y1 describes another headboard having luminescent functions; WO2013131175A1 and CN202696862U describe a bed having sound components incorporated within the headboard; KR1020120104016A describes a bed with a variety of components (lighting units, sound units and controlling tools) also integrated within the headboard.

In view of the number of patent applications regarding the functional and aesthetic design of headboards of a bed, there is clearly a need for new solutions to provide decorative headboards or footboards for bed that would overcome the drawbacks present in the identified prior art documents or have advantages over them.

### SUMMARY

According to an embodiment, there is provided a bed comprising:

a headboard having a forward face or a footboard having a forward face;

wherein at least one of the headboard and the footboard comprises a light board having a front surface and a back surface the light board being integrated to at least one of the headboard and the footboard such that the front surface faces a same direction as the forward face of the headboard or of the footboard, the light board comprising:

a light emitting device;

layers which guide light emitted by the light emitting device toward the front surface; and

a translucent image film contained between the layers and blocking at least partially transmission of the light toward the front surface.

According to an aspect, the light emitting device defines a light emitting layer and further comprises light emitting components which are one of scattered, spread or arranged in arrays over the light emitting layer.

According to an aspect, the layers comprise a diffusion layer disposed in front of the light emitting components, wherein the diffusion layer diffuse light emitted by the light emitting components into a substantially uniform light.

According to an aspect, the layers comprise a frontmost layer which is transparent whereby the translucent image film is located between the frontmost layer and the diffusion layer.

According to an aspect, the light board comprises edges and the light emitting device further comprises a light emitting component disposed about an at least one of the edges.

According to an aspect, the layers comprise a conveying layer disposed adjacent the light emitting device, wherein the conveying layer conveys light emitted by the light emitting component toward the front surface.

According to an aspect, the light board comprises electrical components, and wherein the light board further comprises an electrical area which houses the electrical components, and a display area which houses the light emitting device, the layers and the translucent image film.

According to an aspect, the layers comprise at least two layers, wherein at least one layer is made of either one of an opaque material and a reflective material.

According to an aspect, the light board further comprises a frame, wherein at least one of the layers is attached in a removable manner to the frame so that access to the translucent image film is possible by detaching at least one of the layers from the frame.

According to an embodiment, there is provided a light board for a head or a foot of a bed, the light board comprising:

a frame for attachment to the bed;

a front surface and a back surface;

a light emitting device;

layers which guide light emitted by the light emitting device toward the front surface, the layers being mounted within the frame between the front surface and the back surface; and

a translucent image film contained between the layers and blocking at least partially transmission of the light toward the front surface.

According to an aspect, the light emitting device defines a light emitting layer and further comprises light emitting components which are one of scattered, spread or arranged in arrays over the light emitting layer.

According to an aspect, the layers comprise a diffusion layer disposed in front of the light emitting components, wherein the diffusion layer diffuse light emitted by the light emitting components into a substantially uniform light.

According to an aspect, the light board comprises edges and the light emitting device further comprises a light emitting component disposed about an at least one of the edges.

According to an aspect, the layers comprise a conveying layer disposed adjacent the light emitting device, wherein the conveying layer conveys light emitted by the light emitting component toward the front surface.

According to an aspect, the light board comprises electrical components, and wherein the light board further comprises an electrical area which houses the electrical components, and a display area which houses the light emitting device, the layers and the translucent image film.

According to an embodiment, there is provided a light board comprising:

a frame;

a front surface and a back surface;

a light emitting device;

layers which guide light emitted by the light emitting device toward the front surface, the layers being mounted within the frame between the front surface and the back surface; and

a translucent image film contained between the layers and blocking at least partially transmission of the light toward the front surface.

According to an aspect, the light emitting device defines a light emitting layer and further comprises light emitting components which are one of scattered, spread or arranged in arrays over the light emitting layer.

According to an aspect, the layers comprise a diffusion layer disposed in front of the light emitting components, wherein the diffusion layer diffuse light emitted by the light emitting components into a substantially uniform light.

According to an aspect, the light board comprises edges and the light emitting device further comprises a light emitting component disposed about an at least one of the edges.

According to an aspect, the layers comprise a conveying layer disposed adjacent the light emitting device, wherein the conveying layer conveys light emitted by the light emitting component toward the front surface.

### BRIEF DESCRIPTION OF THE DRAWINGS

Further features and advantages of the present disclosure will become apparent from the following detailed description, taken in combination with the appended drawings, in which:

FIG. 1 is a picture showing an embodiment illustrating particularly the headboard of a bed, with part of the mechanism visible to the eye;

FIG. 2 is a picture showing a close-up view of controls and connections on the headboard according to the embodiment of FIG. 1;

FIG. 3 is a picture showing the bed of FIGS. 1 and 2 without its mattress and featuring a lit headboard and a complementary lit footboard;

FIG. 4 is a schematic side view of the layer components of the light board for a headboard according to a side-lighting embodiment;

FIG. 5 is a picture showing the bed of FIGS. 1 to 3 with mattress and sheets on;

FIG. 6 is a picture showing the bed of FIGS. 1 to 3, and 5 with mattress and sheets on, featuring a lit headboard and a lit footboard;

FIG. 7 provides a schematic of the electric and electronic components of the light board illustrated through FIGS. 1-3, 5-6 and 8-10;

FIG. 8 is a picture of another embodiment showing the front of the headboard of a bed;

FIG. 9 is a picture of the embodiment of the headboard of FIG. 8 showing the lighting components in a back-lighting embodiment;

FIG. 10 is a picture of the embodiment of FIGS. 8-9 according to a showing the diffusion layer removed;

FIG. 11 provides a schematic exploded view of some components according to a back-lighting embodiment; and

FIG. 12 is a picture of another embodiment of the headboard of a bed with electric components in a separate section and a sound bar thereunder.

It will be noted that throughout the appended drawings, like features are identified by like reference numerals.

### DETAILED DESCRIPTION

In embodiments described herein, there are disclosed multi-functional electrically-connected furniture.

Note that throughout the present document, the terms “face” and “surface” are used to refer to a similar structure and therefore should be considered interchangeable.

Similarly, the terms “light emitting device”, “lighting components”, “light source(s)” and “lighting source(s)” also refer to similar structures and should as well be considered interchangeable. Light Emitting Diodes and LEDs are also intended to be interchangeable.

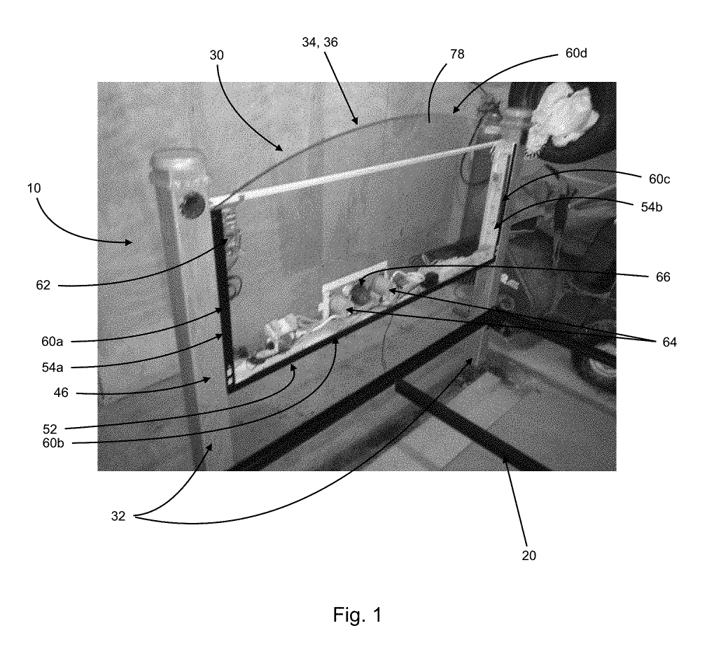

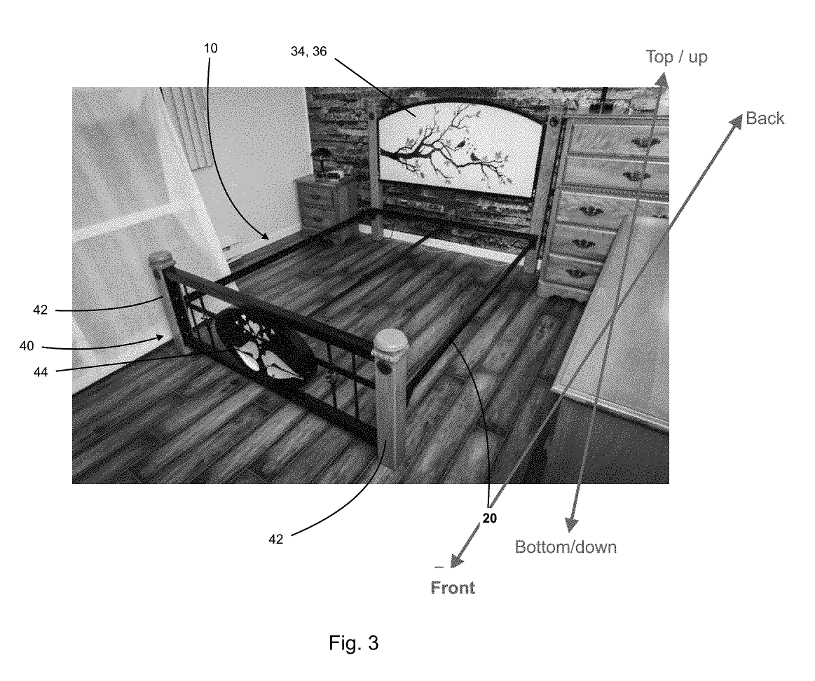

Referring now to the drawings, and more particularly to FIGS. 1 and 3, there is shown a bed 10 according to one embodiment. The bed 10 comprises a bed frame 20 over which a mattress (not shown) is placed, a bed head 30 comprising legs 32 and a headboard 34. As shown, the bed frame 20 is structurally attached to the bed head 30. FIG. 3 shows the bed foot 40 similarly comprising legs 42 and a footboard 44. The bed frame 20 is structurally attached to the bed foot 40 at the foot of the bed 10. A light board 36 is mounted to the headboard 34 such that its front surface faces the same direction as the forward facing surface of the headboard 34. The components of the bed 10 may be assembled or mounted using a variety of solutions, such as using glue, screws, a combination of bolts and (embedded and/or not-embedded) nuts, anchors located and slots to support the weight of components, clips, and additional mounting plates attached or mounted to to-be-joined components.

With the embodiment of FIGS. 1 and 3, the headboard comprises a first leg 42 and a second leg 42 intended to be assembled together with a structure to be placed therebetween to form as a whole the bed head 30. In the present embodiment, the structure consists in a headboard frame 46 having the necessary rigidity, when attached to the legs 42, combine the legs 42 and the headboard frame 46 into a single rigid coherent component on which the bed frame 20 may be attached. With the present embodiment, the headboard frame 46 may be structurally attached to the legs 42 with, alone or in combination, glue, screws, a combination of bolts and leg-embedded nuts, anchors located on the sides of the headboard frame 42 and slots located in the legs to receive and support the weight of the anchors, clips, and additional mounting plates attached or mounted to the back side of the headboard frame 46 and mounted on the legs 42.

For purpose of rendering the description easier and to lighten the description, a set of special references are herein provided and illustrated on FIG. 3. Accordingly, the headboard 34 is located at the back of the bed 10, with the surface close the to the bed frame 20 being the front face or forward face of the headboard 34. The opposed surface being the back face. Similarly, the footboard 44 is located at the front of the bed 10. It features a front face or forward face away from the bed frame 20 and a back face close to the bed frame 20. Accordingly, further components will be described using the same spatial references, namely front, back, top or up, bottom or down.

Returning to FIG. 1, the bed head 30 is shown having as single component of the headboard 34: the light board 36. The light board 36 comprises a bottom frame 52 and side frames 54a-b through which, in this case, the light board 36 is attached to the legs 32. The light board 36 further comprises a control board 62 electrically connected to a power source (not shown). The power source (not shown) may be typically a power plug (not shown) connected via a power cord to the electrical grid, but alternatively, a self-contained power source such as batteries. The light board 36 further comprises lighting components 64 connected to the control board 62 and positioned about one edge among the light board edges 60a-d such that the lighting components 64 are hidden when looking at its front surface, namely the mattress side of the headboard 34. To be noted that the illustrated embodiment consists in a side-lighting light board 36 since the lighting components 64 are positioned about one or more of the edges 60a-d, namely the bottom edge 60b. Practically, the lighting components 64 are usually hidden by one of the frames 52 and 54a-b and/or by the mattress (not shown) when put in place. The light board 36 further comprises ventilation components 66 disposed usually about the lighting components 64 or in the same close-contained space as other components (control board 62 and lighting components 64) when heat from these components needs to be evacuated from the light board 36. The light board 36 further comprises one or more ventilation openings for allowing ventilation through forced circulation or natural circulation of air around heat sources. These ventilation openings are, according to one embodiment, disposed substantially in periphery of the light board 36.

FIG. 1 also shows the front layer 78 part of the light board 36. The front layer 78 is one of multiple layers disposed within the frames 52 and 54a-b; the layers composing the light board 36 and creating a substantially flat surface on the forward facing surface of the headboard 34.

The front layer 78 (aka the transparent layer), normally consisting in the frontmost layer and only layer providing a surface readily accessible by the owner of the bed 10, is typically made of heat-tempered glass, but alternative materials featuring similar security-associated and physical characteristics may also be used.

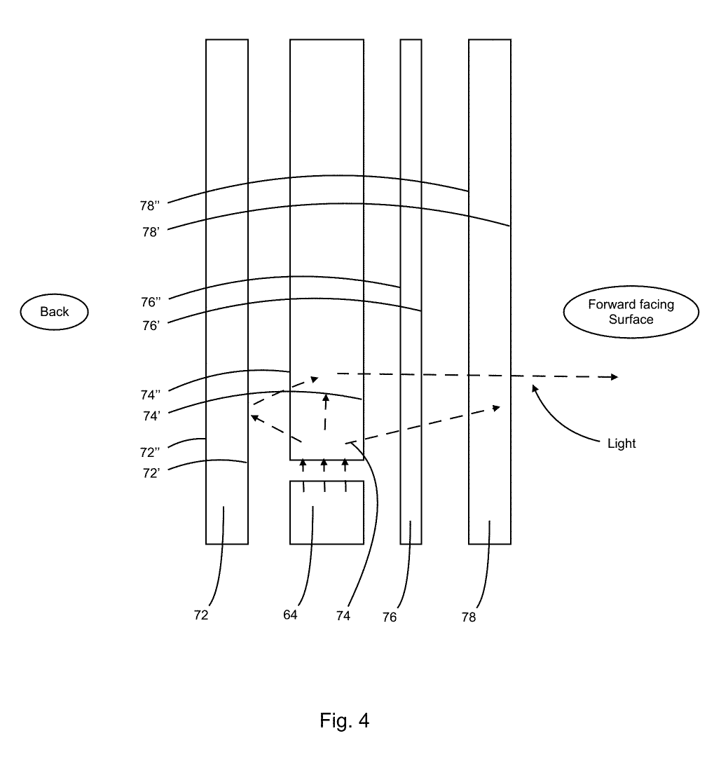

Now referring to FIG. 4, a schematic shows the different layers (with no respect to scale) taking part of the light board 36 according to the above-described embodiment illustrated through FIGS. 1-3, 5-6. Starting with the back face of the light board 36 and moving to the front face of the headboard 34, a back layer 72 is represented. The back layer 72 has a front face 72′ and a back face 72″ defining the back surface of the light board 36. The back layer, or any of its faces 72′ and 72″ are either opaque, made of or covered of reflective material (for reasons which will be explained herein). Closer to the front, a conveying layer 74 made of material capable of transmitting light emitted by the lighting components 64 positioned at at least one of the hidden edges of the conveying layer 74 toward its center and toward its faces 74′ and 74″. In front of the conveying layer 74 is a translucent image film 76 having an image printed thereon allowing partial transmission of the light therethrough; the image covering or defining substantially a display surface. For each part of the image, based on the printed image, the image film 76 is either conveying, conveying partially or not conveying light from its back face 76″ to its front face 76′. Accordingly, it results in an image with lit portions and dark portion viewable from the forward facing surface of the headboard 34.

The light board 36 also comprises a front layer 78 made of material transmitting light from its back face 78″ to its front face 78′ which is visible by a person looking at the face of the headboard 34. The back layer 72, the conveying layer 74, the image film 76 and the front layer 78 compose together a sandwich-like assembly held together by the frames 52 and 54a-b. The front layer 78 is essential transparent so that it does not create any distortion to a viewer looking at the lit image on the image film 76 which is why it is also referred to as the transparent layer. In other embodiment, the transparent layer (front layer 78) is translucent thereby causing some distortion to lit image from the image film 76.

In order to provide a lit image providing the desired decorative characteristics, the light emitted by the lighting components 64 has to travel from the lighting components 64 to the front side (78′) of the light board 36. Accordingly, the conveying layer 74 performs the function of conveying the light toward the center of the headboard 34 as backward and frontward. The back layer 72, made of or covered with reflective or opaque material, either reflects back the light toward the conveying layer 74 or uniquely blocks the light from illuminating a wall or any furniture that could be behind the headboard 34. The light is further transmitted toward the image film 76, which blocks part of the light based on the image printed on the image film 76; the ink (or other material having similar characteristics) blocking at least partially the light. Light conveyed through the image film 76 reaches the front layer 78 wherein light is visible by one facing the front face of the light board 36, accordingly looking also at the front face of the headboard 34.

In order to optimize the result, the layers 72, 74 and 78 and the image film 76 are disposed very close, or with substantially no distance between them. Accordingly, the image film 76 is contained within the layer assembly, between layers, namely the conveying layer 74 and front layer 78.

According to embodiments, the lighting components 64 may vary in nature, being form instance LEDs, fluorescent light source or incandescent light source, with corresponding control components (control board 62) and ventilation components 66 adapted accordingly. Number and localization of the lighting components 64, or light emitting devices, may also vary with respect to the present embodiment. For instance, according to one embodiment, a single lighting component 64 may be disposed about the bottom frame 52. According to another embodiment, lighting components 64 may be disposed about the side frames 54a-b. According to another embodiment, lighting components 64 may be composed of a number of distinct components such as LEDs disposed about the frames 52 and 54a-b at approximately equal distance from one another such as to transmit relatively homogenous light through the conveying layer 74, or in other words according to what can be perceived by one looking at the front face of the headboard 34.

The image film 76 is typically composed of a transparent film on which is printed an image, a motif, etc. With the use of ink that is at least blocking part of the light, a heterogeneously translucent component is provided that has the desired characteristics of conveying a portion of the light reaching its back face 76″ to its front face 76′. The preferred realisation of the image film, for complex images, for instance photographs, consists of a High Definition quality image printed on a film.

It is noteworthy that, while not described through that embodiment, the headboard 34 may feature a light board 36 distinct from the headboard 34 and mounted on the headboard 34. It may even feature a plurality of light boards 36 mounted on the headboard 34, with the discrete light boards being controlled by either discrete control boards 62 or a common control board 62 located within the frame housing one of the light board 36 or mounted elsewhere on the headboard 34.

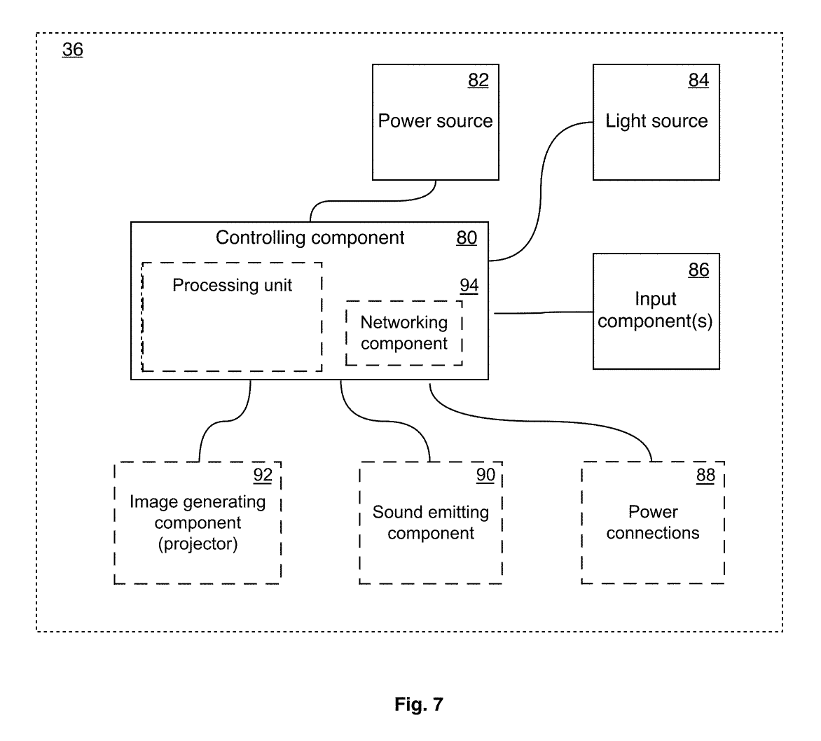

Now referring to FIG. 7, a schematic of the electric and electronic components of the light board 36 is provided. A controlling component 80 embodied, for instance, as an electronic board is connected to a power source 82 (power grid, batteries, etc.). The controlling component 80 is connected to the light source 84 that is used to light up the light board 36. Connection between the light source 84 and the power source 80 may take various forms, but it remains, regardless of the form used for the controlling component 80, that it determines when the light source 84 is turned on or off. Input component(s) 86 are also involves allowing the user to provide commands to the light board 36, namely at least turn on and turn off commands. In its simple realization, the input command takes the form of a physical switch and may be integrated with the controlling component 80 as a single physical component located inside or out of the light board housing. As a more advance realization, a more complex (wired or wireless remote) control may exchange commands with the controlling component 80 (for instance predefined ambiance-activating commands) to the controlling component 80. Additionally, automated input components such as sound monitoring component, light monitoring component and alike, may also take place in or in connection with the light board 36. The light board 36 further comprises, according to the above embodiment, power connections 88 embodied as USB ports, but open to alternatives. The controlling component 80 may also feature (integrated or not) networking component(s) 94 allowing to exchange communication data and commands with external devices. As illustrated by the USB port example, the power connection 88 and networking component(s) 94 may be combined. For instance, a user could connect a personal device (ex. a tablet) to the USB port and recharge the tablet and communicate with the controlling component at the same time. Additionally, the light board 36 may include a sound emitting component 90 such as a sound bar. The sound emitting component 90 may for instance be in communication with the controlling component 80 and be able to play sounds and music. Further, the light board 36 may comprise an image generating component 92 capable of generating and projecting images. Example of an image generating component 92 may be a small projector integrated within the light board 36, or electrically connected to the controlling component 80 regardless its physical location. The image generating component 92 may be embodied as a Pond™ from Touchjet™ or alike, and therefore being able to combine image generating component 92 and input component 86 into a single device.

The controlling component 80 may comprise or be realized as including a networking component 94, including either physical connection capability (ex. USB connection, Ethernet) and/or non-physical connection capability (ex. Wi-Fi, Bluetooth). The controlling component 80 may comprise, depending on realisations, more or less developed processing capabilities and associated components from the above-described hardware realization, a simple hardware/firmware combination to a more complex layout involving for instance a motherboard, a micro-processor and memory (e.g. Flash-type memory) on which a fully functional operating system (ex. Android™) may be stored and used to manage interactions with internal and external components.

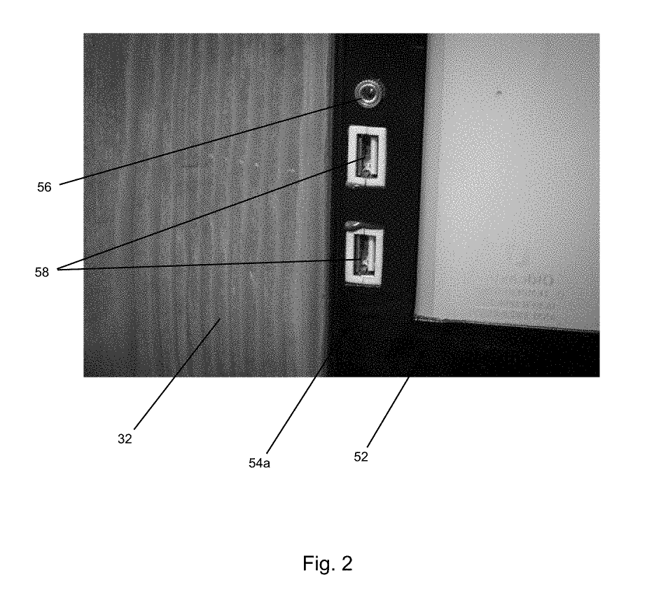

Now referring to FIG. 2, the picture shows control and connection components accessible from the forward facing surface of the headboard 34. Visible control component consists in a power switch 56, in this case a push button, that may be connected to the control board 62, or electrically connected to the lighting components 64, and allows a person to turn on or off the light board 36, which practically results in turning on or off the lighting components 64 and therefore having the light board 36 lit or dark. In other embodiments, the power switch may consist in a dimmable control when the lighting components 64 and other electric components are designed accordingly; that design allowing different lighting levels of the light board 36.

Electrical connectors 58 may for instance be for maintenance purpose or, in this case, be electrical connectors 58 such as USB connectors allowing to charge devices such as cell phones and tablets when plugged in these electrical connectors 58.

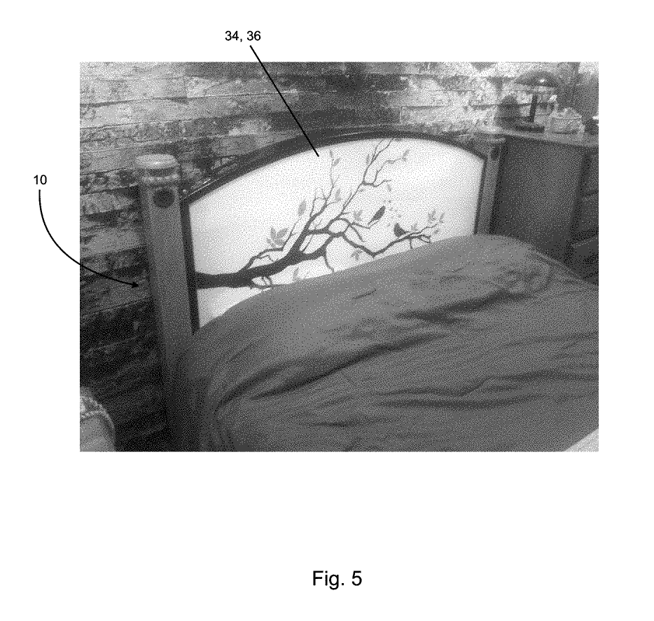

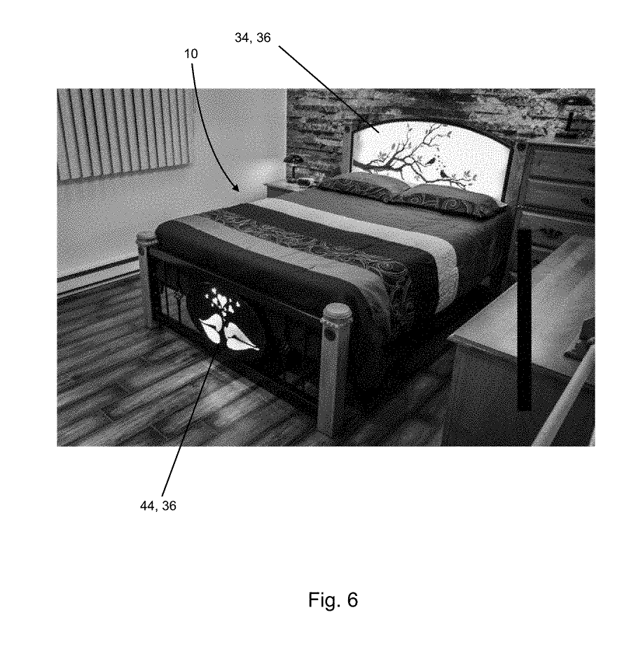

Now referring to FIGS. 5 and 6 pictures shows the headboard 34 of the described embodiment according to typical use. FIG. 5 shows an light board 36 with an illustration of a tree branch bearing birds and leaves.

FIG. 6 provides another view of the same bed 10 with the front face of the footboard 44 visible. According to an embodiment, the footboard 44 has a light board 36 mounted thereon that is electrically connected to light board 36 mounted on the headboard 34, resulting in the light board 36 of the headboard 34 and the footboard 44 being controlled conjunctively. The light board 36 mounted on the footboard 44 may bear a similar structure as the light board 36 mounted on the headboard 34, or may, as illustrated in this case, comprise an additional layer (a.k.a. a masking layer) made of opaque material that may create a cut-off effect. Image film 76 may also not be used. Combined use of an image film 76 and such an additional cut-off opaque layer may provide additional effects when desired.

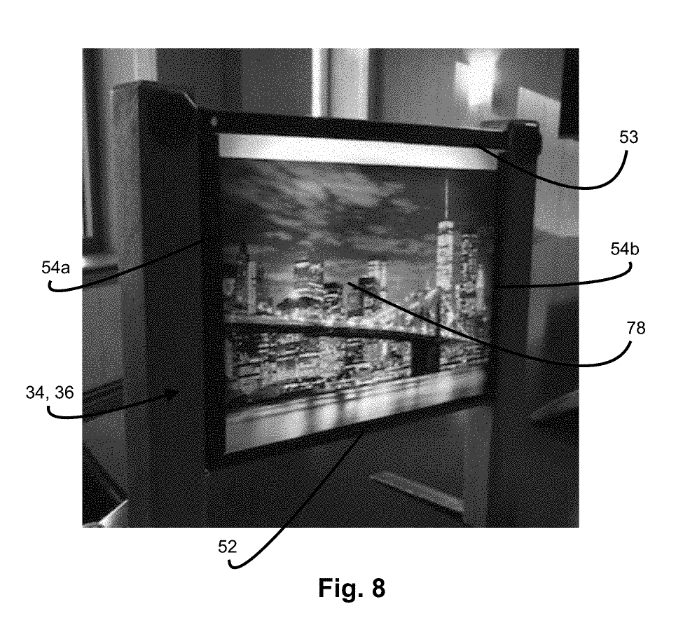

Now referring to FIGS. 8-10, according to another embodiment a bed head 30 is illustrated. The illustrated light board 36 comprises a four-sided frame 52-54 mounted as a headboard 34. Still, the light board 36 may alternatively be mounted on a distinct headboard 34, the headboard 34 comprising framing components being able to be attached to the light board 36 and to attach to the legs 32. Accordingly, the four-sided frame 52-54 ensures the light emitted within the light board 36 to escape else than in a frontward manner through the face layer 78.

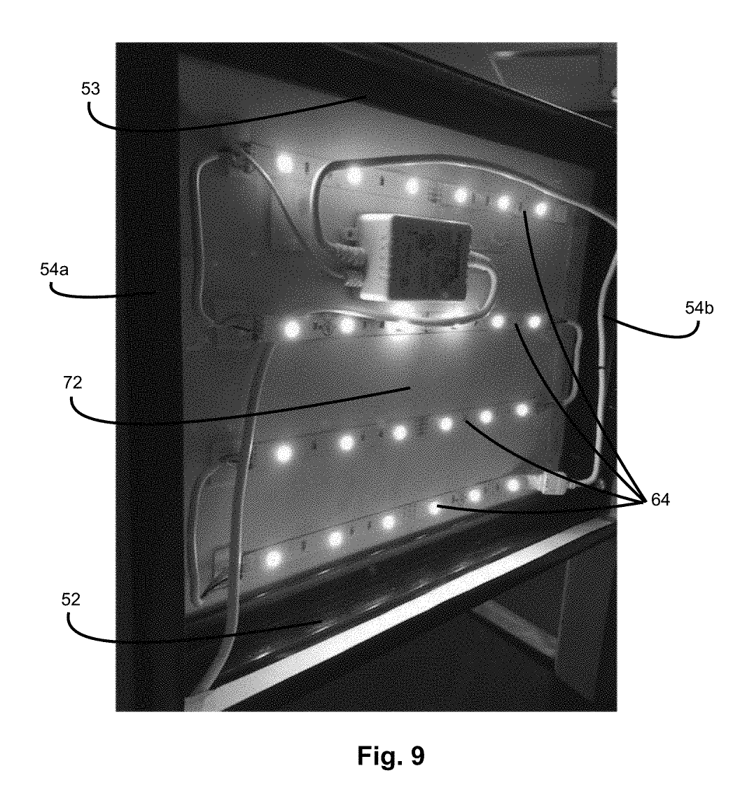

Referring particularly to FIG. 9, there is illustrated alternative configuration and components of the light component 64. Accordingly, the light component 64 may take the form of a series of Light Emitting Diodes (LEDs), each defining a light emitting component, disposed in such a configuration (i.e., scattered, spread, arranged in arrays, etc.) to light up the space in front of the visible back layer 72 as to have the diffusion layer (not shown on FIG. 9), when mounted in front of the arrangement, to provide a relatively uniform light source according to its front face, thereby lighting up uniformly the image film 76 disposed in front of the diffusion layer 75. An example of such a configuration consists in parallel rows of LEDs interconnected as illustrated. Ideal configurations (distance between rows, distance between individual LEDs) depend on physical realisations, but preferred embodiment involves rows of LEDs (such as Red/Green/Blue or RGB Light Emitting Diode system named Mosaic Flex Light made by Sylvania™) spaced apart such as to provide uniform light from the front face of the diffusion layer 75. It also involves the use of a diffusion layer 75 made of acrylic (e.g. Acrylite FF color WT030GT from Evonik Industries) and having a thickness of 0.118 inch, but varying with type of selected light component, and the selected light transmission percentage of the material.

The light component 64 consists, as illustrated, as LEDs. According to that embodiment, selected LEDs are Red/Green/Blue (RGB) LEDs controllable to be a light source of different colours and intensity. Accordingly, a controller may be used to change, for instance gradually, the colour of the RGB LEDs. It therefore becomes possible to light up the image film 76 according to an important range of colors, and the intensity of the lighting. Thus, a range of ambiance programs becomes available.

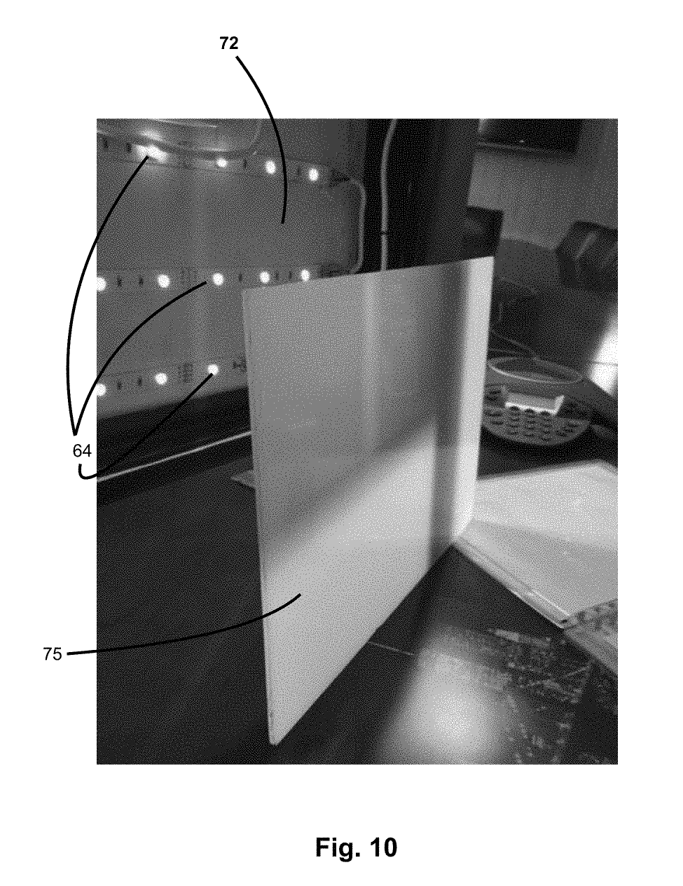

More particularly referring to FIG. 10, the picture shows the back layer 72 used. As illustrated, but not in a limiting manner, the back layer 72 is made of non-translucent material, and preferably of reflective material. According to one embodiment, the preferred material for the back layer 72 may consist of Acrylic as the diffusion layer 75 (for instance from the same manufacturer, color 9M001GT) but with a light transmission percentage close to 0.

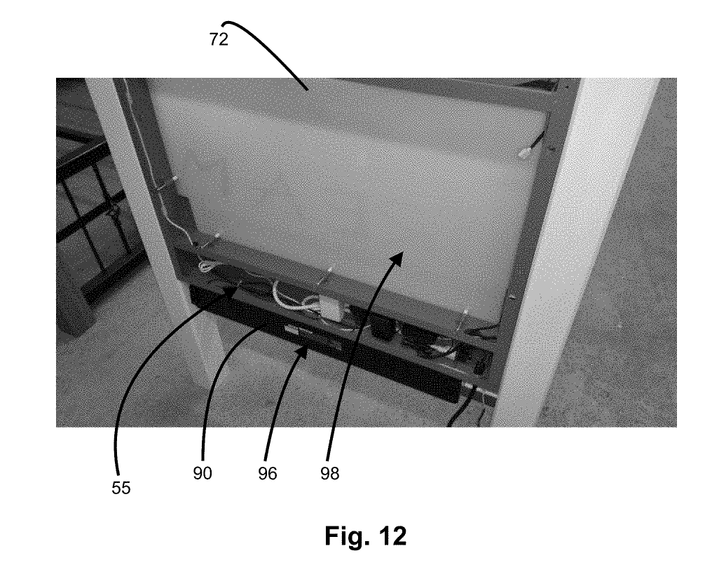

Now additionally referring to FIG. 12, an embodiment comprises a sound emitting component 90, embodied as a sound bar, disposed below the bottom frame 52 and electrically connected to the control board (not shown). The use of a sound bar as a sound emitting component 90 mounted on the headboard 34 allows to provide an extended range of ambiance involving both image, light and sound/music. The music to be played by the sound emitting component 90 may, for instance, be communicated to the controlling component 80 from a personal device (for instance a tablet, a personal music player such as an iPod™, or any other source) using Bluetooth™ technology.

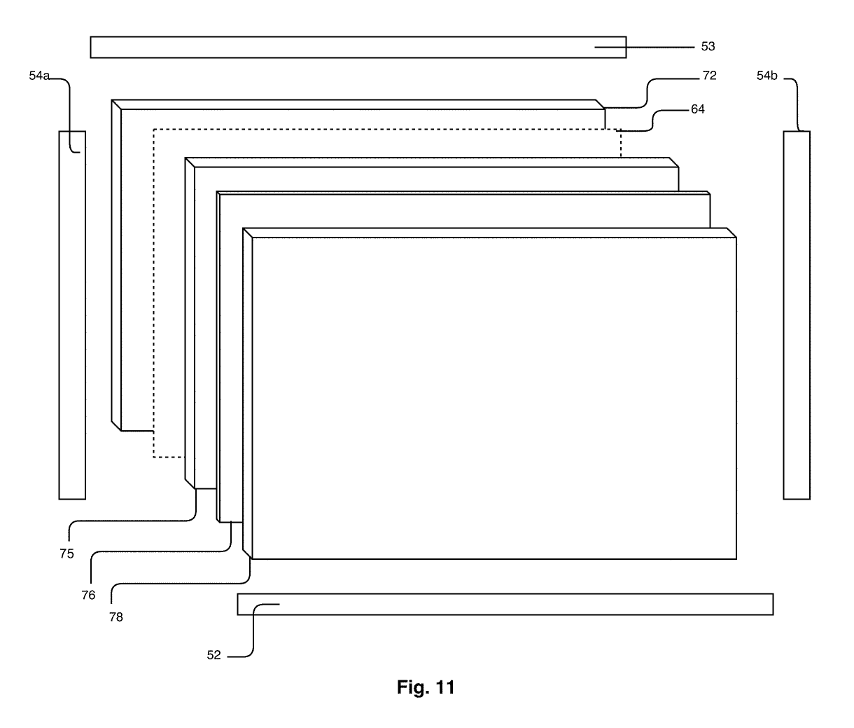

FIG. 11 provides an exploded view of some components of a back-lighting embodiment of the light board 36 showing the sound bar/sound emitting component 90 located below the bottom frame 52. The bottom frame 52, the side frames 54a,b and the top frame 53 encloses the display components, namely the front layer 78, the image film 76, the diffusion layer 75, a light emitting layer wherein the light component 64 is enclosed, and the back layer 72. Connection between the light component 64 and the controlling component 80 is illustrated through a dashes line since the controlling component 80 may be outside housing defined by the frames 53-54.

Back referring to FIGS. 8-10, the complementary components (controlling component 80, input component(s) 86, ventilation component 66 when needed, etc.) may be housed outside the frame 52-54, or within the frame 52-54 in a location for instance back to the back layer 72. Particularly referring to FIG. 12, electrical components are in an additional frame box 55 below the frame 52-54. Accordingly, by limiting the components located within the space occupied by the light source 64 between the back layer 72 and the conveying layer 74, a better light quality is transmitted to the image film 76, and thus to the front face 78′ of the light board 36.

Now referring particularly to FIG. 12, the frame may comprise two areas, namely an electrical area 96 and a display area 98 exclusive to each other, as physically divided from each other by a dividing wall. The electrical area 96, located at the bottom and normally hidden by the mattress, defines a confined area wherein the majority of the electrical components (for example transformers, control boards, heat fan, connections, batteries, electrical cords, etc.) are located. The frame may comprise openings between the electrical area 96 and the display area 98 through which cables feeding the light component 64 may go. The electrical area 96 may also comprise ventilation opening for ventilation purpose. Since no light is emitted from the electrical area 96, the ventilation opening may be located in the back wall section covering the electrical area 96. They may also be located in the bottom wall and/or in the top wall that is the conjunct wall dividing the electrical area 96 from the light area 98. The light area 98 comprises the components listed in relation to the description of FIG. 4 and FIG. 11 depending on whether it is a side-lighting embodiment or a back-lighting embodiment.

Alternative furniture elements may be the object of the present light board 36, from mounted on one board composing a furniture element such as part of a night stand. Table tops, bar front boards, wall boards and other furniture or decorative elements may also be the object of customization using the present light board 36.

Additionally, it may be conceivable in some cases to use a dynamic LED-type or OLED (Organic Light Emitting Diode/Organic LED) type screen to customize appearance of some furniture elements. Accordingly, controlling component 80 needs to be adapted thereto.

### Use and Customization of the Light Board

The present light board 36 offers a range of options and opportunities as how to use the light board 36 and the possible associated functionalities.

Using RGB LEDs and an advanced controlling component 80, and optionally additionally with a sound bar 90, the light board 36 may be programmed to perform numerous ambiance programs already programmed in memory of the controlling component 80, or transmitted to the controlling component 80 using an Ethernet-connected, USB (Universal Serial Bus)-connected, Wi-Fi-connected or Bluetooth™-connected device. For instance, using a remote control, a user may activate an ambiance program setting up the color and intensity of the light component 64, setting up a variable ambiance program changing according to provided parameters (ex. time of day). Other devices may communicate with the light board 36 to set up, activate or deactivate ambiance programs. For instance, an hotel central system may communicate with the light board 36 to set up an ambiance program based on the wake up time selected by the room patron. According to another alternative, a user through an app/application on a cell phone may control similar ambiance programs. The user may even set up the music to be associated with the wake up program such as a gradual lightening up and changing the color of the light board 36 to simulate dawn. A musical ambiance program having the volume of the music increasing as the time passes since the trigger time of the wake up program may accompany the light ambiance program.

According to an option, the footboard 44 may include a mechanical screen (not illustrated) that may be erected upon request. The screen erection mechanism may be controlled by the same controlling component 80 as the light board 36. The light board 36 may comprise an image projecting component, for example a projector (not illustrated) or alike as discussed for, for instance, projecting movies, television shows, an interactive Internet browser environment, etc. The projections could take place on the erectable screen or on the ceiling. Based on the controlling component 80 and other components involved, such possibilities remain for the use of the multi-functional bed 10 comprising a light board 36.

Typically, the business model may involve that someone intending to buy a bed 10 comprising a light board 36 may select an image to take place among a bank of predefined images, or may command a personal image. The future buyer could go on a website and select the image they desire for the bed headboard 34. They may also upload a personal image to the website as the desired image to be afterwards printed on an image film 76. If a retailer number and/or a retailer command number or alternative appropriate information is associated with the order, the image may be sent to the retailer location to be installed in the light board by the retailer prior to delivery.

After purchase, the owner of such a bed 10 could go on the website and place an order with the appropriate information, for instance the light board 36 serial number or model number. Accordingly, the owner could receive the printed image film 76 of the selected image and an how-to manual describing the steps involved in customizing the light board 36. The owner would then remove or detach one of the layers from the frame of the light board 36 to access the image film 76. They would then remove the previous film image 76 from the light board 36, place the new acquired image film 76 in replacement, and reattach the removed layer to the frame of the light board 36. Thus, with a new image film 76 on hand, the owner could personally customize the bed 10.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A bed comprising:
a headboard having a forward face or a footboard having a forward face; wherein at least one of the headboard and the footboard comprises a light board having a front surface and a back surface the light board being integrated to at least one of the headboard and the footboard such that the front surface faces a same direction as the forward face of the headboard or of the footboard, the light board comprising:
a light emitting device;
layers which guide light emitted by the light emitting device toward the front surface; and
a translucent image film contained between the layers and blocking at least partially transmission of the light toward the front surface.

2. The bed of claim 1, wherein the light emitting device defines a light emitting layer and further comprises light emitting components which are one of scattered, spread or arranged in arrays over the light emitting layer.

3. The bed of claim 2, wherein the layers comprise a diffusion layer disposed in front of the light emitting components, wherein the diffusion layer diffuse light emitted by the light emitting components into a substantially uniform light.

4. The bed of claim 3, wherein the layers comprise a frontmost layer which is transparent whereby the translucent image film is located between the frontmost layer and the diffusion layer.

5. The bed of claim 1, wherein the light board comprises edges and the light emitting device further comprises a light emitting component disposed about an at least one of the edges.

6. The bed of claim 5, wherein the layers comprise a conveying layer disposed adjacent the light emitting device, wherein the conveying layer conveys light emitted by the light emitting component toward the front surface.

7. The bed of claim 1, wherein the light board comprises electrical components, and wherein the light board further comprises an electrical area which houses the electrical components, and a display area which houses the light emitting device, the layers and the translucent image film.

8. The bed of claim 1, wherein the layers comprise at least two layers, wherein at least one layer is made of either one of an opaque material and a reflective material.

9. The bed of claim 1, wherein the light board further comprises a frame, wherein at least one of the layers is attached in a removable manner to the frame so that access to the translucent image film is possible by detaching at least one of the layers from the frame.

10. A light board for a head or a foot of a bed, the light board comprising:
a frame for attachment to the bed;
a front surface and a back surface;
a light emitting device;
layers which guide light emitted by the light emitting device toward the front surface, the layers being mounted within the frame between the front surface and the back surface; and
a translucent image film contained between the layers and blocking at least partially transmission of the light toward the front surface.

11. The light board of claim 10, wherein the light emitting device defines a light emitting layer and further comprises light emitting components which are one of scattered, spread or arranged in arrays over the light emitting layer.

12. The light board of claim 11, wherein the layers comprise a diffusion layer disposed in front of the light emitting components, wherein the diffusion layer diffuse light emitted by the light emitting components into a substantially uniform light.

13. The light board of claim 10, wherein the light board comprises edges and the light emitting device further comprises a light emitting component disposed about an at least one of the edges.

14. The light board of claim 13, wherein the layers comprise a conveying layer disposed adjacent the light emitting device, wherein the conveying layer conveys light emitted by the light emitting component toward the front surface.

15. The light board of claim 10, wherein the light board comprises electrical components, and wherein the light board further comprises an electrical area which houses the electrical components, and a display area which houses the light emitting device, the layers and the translucent image film.

16. A light board comprising:
a frame;
a front surface and a back surface;
a light emitting device;
layers which guide light emitted by the light emitting device toward the front surface, the layers being mounted within the frame between the front surface and the back surface; and
a translucent image film contained between the layers and blocking at least partially transmission of the light toward the front surface.

17. The light board of claim 16, wherein the light emitting device defines a light emitting layer and further comprises light emitting components which are one of scattered, spread or arranged in arrays over the light emitting layer.

18. The light board of claim 17, wherein the layers comprise a diffusion layer disposed in front of the light emitting components, wherein the diffusion layer diffuse light emitted by the light emitting components into a substantially uniform light.

19. The light board of claim 16, wherein the light board comprises edges and the light emitting device further comprises a light emitting component disposed about an at least one of the edges.

20. The light board of claim 19, wherein the layers comprise a conveying layer disposed adjacent the light emitting device, wherein the conveying layer conveys light emitted by the light emitting component toward the front surface.
